(19) United States
(12) Patent Application Publication
(10) Pub. No.: US 2004/0088374 A1
(43) Pub. Date: May 6, 2004

(54) Aggregation and sharing of patient data

(76) Inventors: James D. Webb, Maple Grove, MN (US); Chester G. Nelson, Plymouth, MN (US)

Correspondence Address: MEDTRONIC, INC., 710 MEDTRONIC PARKWAY NE, MS-LC340, MINNEAPOLIS, MN, 55432-5604, US

(21) Appl. No.: 10/284,921

(22) Filed: Oct. 31, 2002

(51) Int. Cl. G06F 15/16

(52) U.S. Cl. 709/218; 715/501.1

(57) ABSTRACT

Techniques are described for acquisition of physiological data from a medical device, and manipulation and storage of the physiological data in a format that can allows the data to easily be shared between systems and viewed using different applications. Moreover, the techniques provide for the aggregation of the physiological data acquired from a medical device over multiple telemetry sessions. A system, for example, includes a plurality of medical device programmers to collect physiology data via telemetry sessions with medical devices, and a programmer gateway to receive the session data from the medical device programmers and to process the session data for aggregation in one or more data stores. The session data may include metadata that conforms to a data description language, such as XML, and the programmer gateway may execute a translation engine to store portions of the session data within respective data stores based on the metadata.

### TECHNICAL FIELD

The invention relates generally to medical devices and, more particularly, to sharing of physiological data generated by the medical devices.

### BACKGROUND

Medical devices may monitor and delivery therapy to a patient. Moreover, these medical devices may be used at different times, and in a variety of locations. One or more medical devices may, for example, be used to provide medical treatment or monitor physiological conditions while the patient resides within his or her home or office. At other times, the patient may visit clinics or hospitals where different medical devices may be used. These disparate medical devices generate clinically significant physiological data relating to the symptoms and condition of the patient.

This physiological data is often collected by use of telemetry, which generally refers to communication of data, instructions, and the like between a medical device and a medical device programmer. For example, the programmer may use telemetry to interrogate the medical device to acquire the physiological data. In particular, the programmer may obtain diagnostic data, event marker data, activity data and other data collected or identified by the medical device. The physiological data may be used to program the medical device for delivery of new or modified therapies. In this manner, telemetry between a medical device and a programmer can be used to improve or enhance medical device therapy. A communication “session” is established to communicate the physiological data to the programmer, and to communicate any controls or commands from the programmer to the medical device.

Many implantable medical devices (IMDs) support telemetry. Examples of an IMD include implantable cardiac pacemakers, implantable defibrillators, implantable pacemaker/cardioverter/defibrillators, implantable muscular stimulus devices, implantable brain stimulators, other implantable organ stimulation devices, implantable drug delivery devices, implantable monitors, and the like. Telemetry, however, is not limited to communication with IMDs. For example, telemetry may also be used to communicate with non-implanted medical devices in substantially the same way as it is used with IMDs.

The evolution and advancement of telemetry has yielded a number of advantages including, for example, improved communication integrity, improved data transmission rates, improved communication security, and the like. Moreover, as new therapeutic techniques are developed, telemetry allows the new techniques to be programmed into older medical devices, including devices previously implanted in a patient. Unfortunately, the evolution of telemetry has also resulted in the proliferation of a wide variety of different systems and communication techniques that generally require a unique programmer for communication with each type of device. Consequently, different types of medical devices, medical devices manufactured by different companies, or even similar medical devices manufactured by the same company, often employ different telemetry techniques. Moreover, the medical devices and the programmers typically produce physiological data in a variety of non-standard formats. These formats often require specialized systems for storing and viewing the collected physiological data, and often make difficult the exchange of the data between systems, as well as the sharing of the data with others.

### SUMMARY

In general, the invention is directed to techniques for acquisition of session data from a medical device, and manipulation and storage of the session data in a format that allows the data to easily be shared between systems and viewed using different applications. Moreover, the techniques provide for the aggregation of the session data acquired from a medical device over multiple telemetry sessions. In this manner, a clinician may easily view and interpret the aggregated data.

As described herein, a medical device programmer interacts with a medical device to acquire session data, and processes the session data into a format that conforms to a data description language, such as the extensible markup language (XML). In other words, the raw session data is processed to produce “constrained” session data that includes the raw data, as well as metadata that encapsulates and describes the raw data. The metadata conforms to the data description language, and defines a number of data types, or elements, for describing the raw session data. Alternatively, the medical device may output the session data with embedded metadata and in a form that already complies with the data description language.

Session data acquired via multiple sessions is processed and aggregated within one or more data stores. More specifically, a translation engine processes the session data to identify and extract portions of the session data based on the embedded XML elements. The translation engine may store the extracted data in XML format within one or more of the data stores. In particular, data having a common XML data type may be stored in a common data store. The translation engine determines whether the extracted data was previously received from the programmer during an early visit by the patient, thereby avoiding redundant data storage that may be confusing to the clinician. The translation engine and data stores may reside within the programmer, within a central programmer gateway that aggregates data from multiple programmers, or within one or more network, such as an application server, a web server, or the like.

The aggregated data within the data stores may be easily shared with other systems, or presented to remote clinicians. In particular, an Extensible Style Language Transformations (XSLT) processor transforms the aggregated data into serialized HTML, Scalar Vector Graphics (SVG), or other viewable data suitable for rendering one or more web pages for display by a web browser or other software application. In particular, the XSLT processor retrieves the session data aggregated within the data stores, and transforms the session data in accordance with XSLT style sheets. In this manner, the session data may easily be manipulated and displayed using different style sheets, without requiring the use of complex database system or other complex software application.

In one embodiment, the invention is directed to a device comprising a data processing module to transform session data received from a medical device via a telemetry session into one or more web pages in accordance with one or more style sheets, and a web server to present the web pages to a remote user.

In another embodiment, the invention is directed to a device comprising a translation engine to receive session data acquired via telemetry sessions with a medical device, and to process the session data for aggregation in one or more data stores in a format that conforms to a data description language.

In another embodiment, the invention is directed to a system comprising a plurality of medical device programmers to collect physiology data via telemetry sessions with medical devices, and a programmer gateway to receive the session data from the medical device programmers and to process the session data for aggregation in one or more data stores.

In another embodiment, the invention is directed to a system comprising a plurality of distributed peer servers having data stores of session data, and a client device executing a peer-to-peer client software application for accessing the session data directly from the distributed servers.

In another embodiment, the invention is directed to a method comprising receiving session data acquired via telemetry sessions with a medical device, and processing the session data for aggregation in one or more data stores and in a format that conforms to a data description language.

In another embodiment, the invention is directed to a computer-readable medium comprising instructions to cause a processor to receive session data acquired via telemetry sessions with a medical device, and process the session data for aggregation in one or more data stores in a format that conforms to a data description language.

In another embodiment, the invention is directed to a method comprising receiving login information from a clinician, accessing clinician-specific preferences based on the login information, and applying the clinician-specific preferences to a medical device programmer. The aggregation and filtering enable previous clinician-based preferences and nominals to be accurately shared across programmers and internet-based user sessions, clinicians treating a patient, as well as members of physician groups, clinics, and hospitals.

The techniques may offer one or more advantages. For example, the techniques may allow a programmer or a programmer gateway to aggregate the session data in a form that may easily be viewed by a clinician. For example, a clinician within a health care facility may view the aggregated data by directly accessing the programmer, e.g., during a current examination of a patient. Other clinicians may access the aggregated data remotely via a network using software including a web browser or a peer-to-peer file sharing application.

Further, the techniques may allow a clinician to more easily view and interpret data collected over multiple sessions. In particular, data that can either span, or be duplicated across, multiple patient sessions can be identified and extracted from the session data, and then recombined with other data of that type. For example, an episode that exists in multiple sets of received session data can be identified and extracted, with the instance having the most complete detailed data being added to the associated data store. The other duplicate data can be discarded. A user, such as a clinician, can then navigate all the recombined data, e.g., all of the episodes in an aggregated list, and is presented with a complete detail for the example episode, regardless of whether the detail spanned or was duplicated in multiple telemetry sessions. In this manner, by extracting data from individual sessions, and aggregating data of similar data types, e.g., episodes, the clinician may be able to more easily obtain a complete perspective on the session data obtained from a medical device.

In addition, the techniques allow session data to be aggregated and displayed to a user without necessarily requiring the use of a database system, and in particular, a relational database system, which can be complex and expensive to implement. Further, the techniques provide flexibility in handling a variety of data types, such as new data provided by previously unsupported medical devices or new versions of existing medical devices.

Moreover, the techniques facilitate a peer-to-peer, file-based sharing of data between remote clinics, universities, and other entities. These entities, for example, may elect to “publish,” i.e., make available, all or portions of the aggregated data for viewing by authorized users. The distributed entities, therefore, need not necessarily communicate the data to a central patient management system, thereby giving each entity complete control over the physiological data that is available. Because the physiological data is stored and aggregated in a form that can easily be manipulated and displayed, e.g., using customized style sheets, the entities may render and display the physiological data differently as needed, yet maintain the data in a common, readily exchangeable format.

The above summary of the invention is not intended to describe every embodiment of the invention. The details of one or more embodiments of the invention are set forth in the accompanying drawings and the description below. Other features, objects, and advantages of the invention may be apparent from the description and drawings, and from the claims.

### BRIEF DESCRIPTION OF DRAWINGS

FIG. 1 illustrates an example system in which a health care facility includes a plurality of medical device programmers for communicating with medical devices (MDs).

FIG. 2 is a block diagram illustrating the programmer gateway in further detail.

FIG. 3 is a block diagram illustrating an example embodiment of XML data stores that are organized as separate XML files.

FIG. 4 is a flowchart illustrating example operation of the system of FIG. 1.

FIG. 5 is a block diagram illustrating an example system that makes use peer-to-peer, file-based sharing of physiological data between distributed entities.

FIGS. 6-10 illustrate example web pages presented by a programmer gateway based on the data aggregated within the XML data stores.

### DETAILED DESCRIPTION

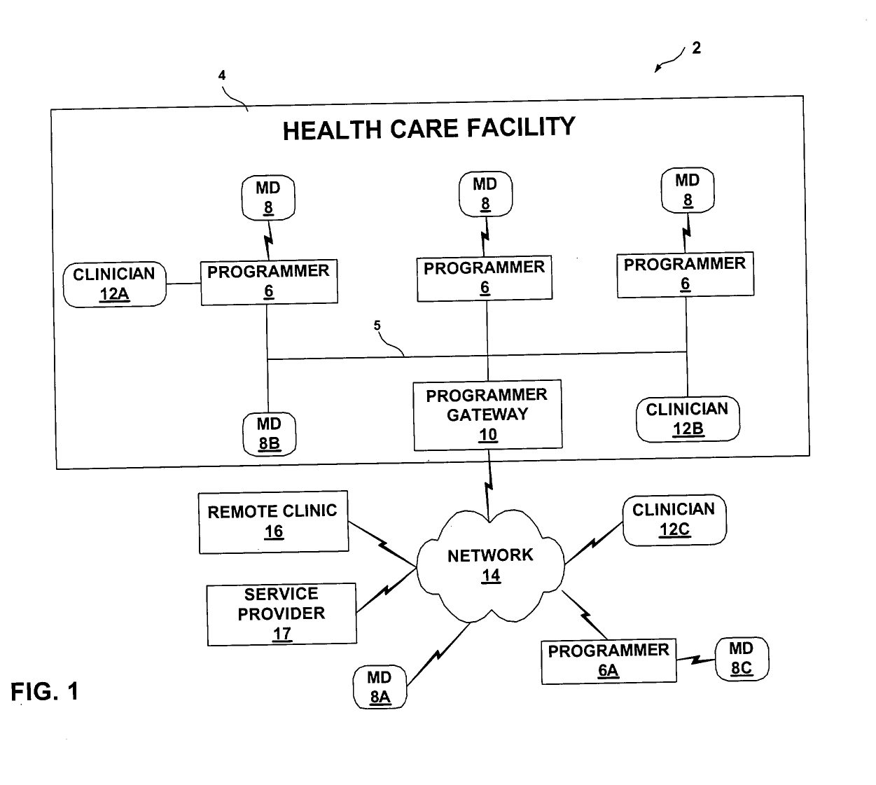

FIG. 1 illustrates an example system 2 in which a health care facility includes a plurality of medical device programmers 6 for communicating with medical devices (MDs) 8. Programmers 6 initiate communication “sessions” with medical devices 8 to deliver particular therapies to the patients, and to interrogate MDs 8 to obtain “session” data. The session data may include, for example, physiological data, e.g., diagnostic data, event marker data, activity data and other data currently stored by medical devices. Upon communicating the session data to programmers 6, MDs 8 may clear all or portions of the session data from memory residing on the MDs.

As described herein, the components of system 2 apply techniques for acquisition of session data from MDs 8, and manipulation and storage of the session data in a format that allows the data to easily be shared. Moreover, the techniques provide for the aggregation of the session data acquired over multiple telemetry sessions.

Programmers 6 and MDs 8 communicate using one or more forms of wired or wireless data transfer in accordance with one or more wireless communication techniques, such as standard RF telemetry protocols. Programmers 6 and MDs 8 may use, for example, electromagnetic signals, such as radio frequency (RF) signals and infrared (IR) frequency signals, sound waves, or even the patient's flesh as the transmission medium. For example, conventional RF telemetry communication protocols for communicating within implanted medical devices may be employed to effect communications between MDs 8 and programmers 6. These and other protocols may be used with external medical devices. One example protocol, commonly referred to as Bluetooth, uses short-range 2.4 GHz radio technology employed to transport data between devices. Other possible protocols include IEEE 802.11a, 802.11b, and 802.11g, which are designed for wireless networking.

MDs 8 may be any of a variety of medical devices. For example, IMDs may take the form of implantable medical devices. One example of an implantable medical device is a pacemaker. Such a device typically includes at least one pacing and sensing lead for delivery of pacing pulses to a heart of patient 5. Another example of an implantable medical device is a pacemaker-cardioverter-defibrillator (“PCD”). Other examples include an implantable brain stimulator, an implantable gastric system stimulator, an implantable nerve stimulator or muscle stimulator, an implantable lower colon stimulator (e.g., in graciloplasty applications), an implantable drug or beneficial agent dispenser or pump, an implantable cardiac signal loop or other type of recorder or monitor, an implantable gene therapy delivery device, an implantable incontinence prevention or monitoring device, an implantable insulin pump or monitoring device, and so on. Thus, programmers 6 may receive a wide variety of session data including heart rate, heart rate variability, blood glucose levels, oxygen saturation, partial pressure of oxygen in the blood, blood pressure, baro-reflex measures, electrogram morphologies, lung wetness, and the like.

Similarly, MDs 8 may be any of a variety of external medical devices configured for interrogation by a programmer 6. For example, MDs 8 may include a variety of patient monitoring devices, such as an external blood pressure monitor, an external heart rate monitor that measure heart rate and heart rate variability, an external blood glucose monitor, an electronic questionnaire regarding patient systems or status, a Holter monitor, an external EKG or ECG monitor, an external cardiac signal loop recorder, a temporary cardiac pacing system having an external pulse generator, and the like. In addition, MDs 8 may include external drug delivery systems that may provide physiological data in the form of recent dosage levels, dosing history, and the like. Another example is an external device for testing the blood to provide a variety of information, such as prothrombin time, which may assist in titrating anti-coagulation medication or the current levels of B-type natriuretic peptide (BNP), which may aid the diagnosis and management of congestive heart failure (CHF). Consequently, MDs 8 may provide a wealth of information related to the status and treatment of the patients.

Programmers 6 collect the session data from MDs 8, and communicate the session data to a programmer gateway 10 for aggregation. In particular, each time a patient visits health care facility 4, a clinician, e.g., clinician 12A, uses one or more of programmers 6 to establish a communication session with one or more of MDs 8. The programmer 6 communicates the session data to gateway 10, which acts as a central repository for aggregation of the session data. In other words, gateway 10 aggregates any newly acquired session data for the patient with any previously collected session data. Further, as illustrated by MDs 8A, 8B, a network-enabled medical device may communicate session data directly to programmer gateway 10 or other server for aggregation without requiring a telemetry session with a programmer 6. In addition, session data may be received via a remote programmer 6A coupled to MD 8C.

As described in detail herein, programmers 6 and gateway 10 store the session data in one or more data stores, such as files or databases, and may store the session data in a format that conforms to a data description language, such as the extensible markup language (XML). The data description language describes the format, organization and structure of the aggregated data. Although the principles of the invention are illustrated with reference to XML for exemplary purposes, the invention is not so limited, and the techniques can be readily applied using other data description languages. Other example languages include Extensible Style Language (XSL), Extensible Linking Language (XLL), Standardized Multimedia Authoring Language (SMIL), as well as variations of the Standard Generalized Markup Language (SGML).

Consequently, programmers 6 and gateway 10 aggregate the session data in a form that may easily be viewed by clinicians 12. For example, a clinician 12A within health care facility 4 may view the aggregated data by directly accessing one of programmers 6, e.g., during a current examination of a patient. Clinician 12B may access the aggregated data via network 14. Further, the aggregated data may easily be accessed by a remote clinician 12C or a remote clinic 16 via network 14 coupled to programmer gateway 10.

Programmers 6 may maintain local data stores in accordance with the form described herein, and may also replicate the session data to programmer gateway 10 for further aggregation. In other words, each programmer 6 may store and aggregate session data for the MDs from which each programmer communicates. If programmer gateway 10 is present, programmers 6 may replicate the session data to programmer gateway 10 for aggregation with session data collected by the other programmers. Further, programmer gateway 10 may communicate the aggregated data to third-party service provider 17 that aggregates data from multiple health care facilities or other organizations.

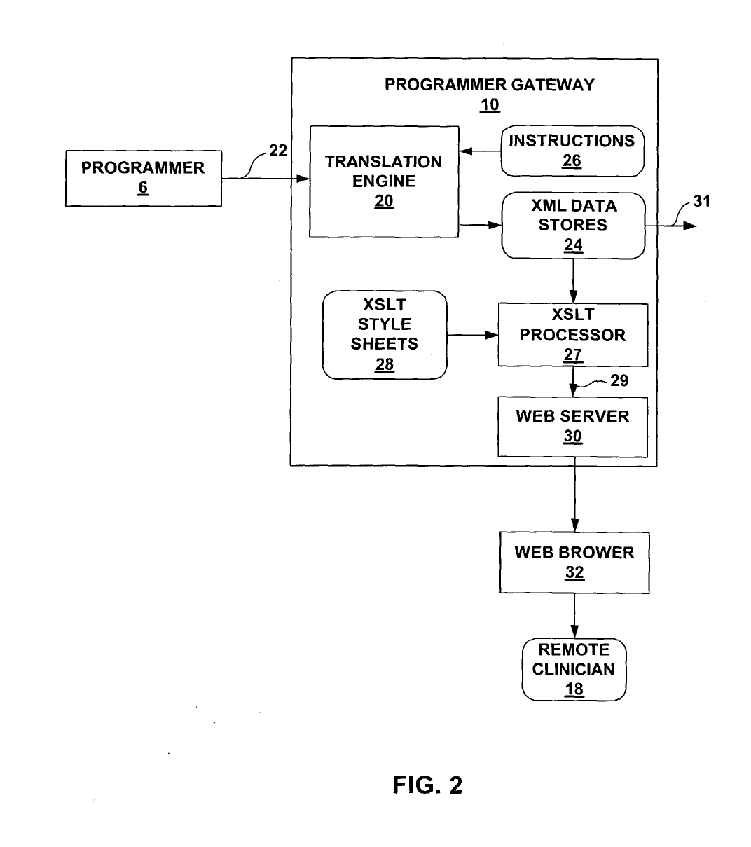

FIG. 2 is a block diagram illustrating gateway 10 in further detail. In particular, gateway 10 includes a translation engine 20 that receives session data 22 from a programmer 6, and processes the session data for aggregation within XML data stores 24. Specifically, translation engine 20 may receive session data 22, and may pre-process the session data into XML form. In other words, translation engine 30 may identify the session data, and insert metadata to encapsulate and describe the session data in accordance with defined data types. Translation engine 20 need not necessarily pre-process session data 22 when the session data is received from a programmer in XML format. Storage logic (not shown) within translation engine 20 parse the XML-compliant session data, and manipulate the session data for storage in a plurality of files in XML format based on the data type.

In particular, session data of a particular type can either span, or be duplicated across, multiple patient sessions. Translation engine 20 can identify and extract the data from the session data 22 based on data type, and then recombine the data within XML data stores 24 with other data of that type. For example, an episode that exists in multiple sets of received session data can be identified and extracted, with the instance having the most complete detailed data being added to the associated data store. The other duplicate data can be discarded. A user, such as clinician 18, can then navigate all the recombined data, e.g., all of the episodes in an aggregated list, and is presented with a complete detail for the example episode, regardless of whether the detail spanned or was duplicated in multiple telemetry sessions. In this manner, by viewing data extracted from individual sessions, and aggregated with data of similar data types, e.g., episodes, clinician 18 may be able to more easily obtain a complete perspective on the session data obtained from a medical device.

Translation engine 20 operates in accordance with translation instructions 26, which may be provided in XML format. The instruction may also be provided, at least in part, in accordance with a procedural language of other software technologies, such as Java, C, C++, Visual Basic, ASP, COM objects, Java Beans, ActiveX components, Web Services, and the like. XML data stores may be stored on a computer-readable medium, such as a magnetic or optical medium, memory, or the like.

Web server 30 provides a web-enabled interface by which a clinician 12 may browse and view the aggregated data via web browser 32. In one configuration, web servers 30 execute web server software, such as Internet Information Server™ from Microsoft Corporation, of Redmond, Wash. Web server 30 may execute a variety of software modules including Active Server Pages, Java scripts, Java Applets, Lotus scripts, web pages written in hypertext markup language (HTML) or dynamic HTML, extensible markup language (XML), component object module (COM) objects, and the like.

Extensible Style Language Transformations (XSLT) processor 27 is a data processing module that transforms the aggregated data into serialized HTML 29 or other viewable data suitable for rendering one or more web pages for display by web server 30. Other forms of viewable data include XHTML, Flash, PDF, Scalar Vector Graphics (SVG), and the like. In particular, XSLT processor 27 retrieves the aggregated data from XML data stores 24, and transforms the XML in accordance with XSLT style sheets 28.

Programmer gateway 10 may also export aggregated data 31 from XML data stores. For example, the exported aggregated data may be communicated or uploaded to a third party service provider that aggregates data from multiple health care facilities or other organizations.

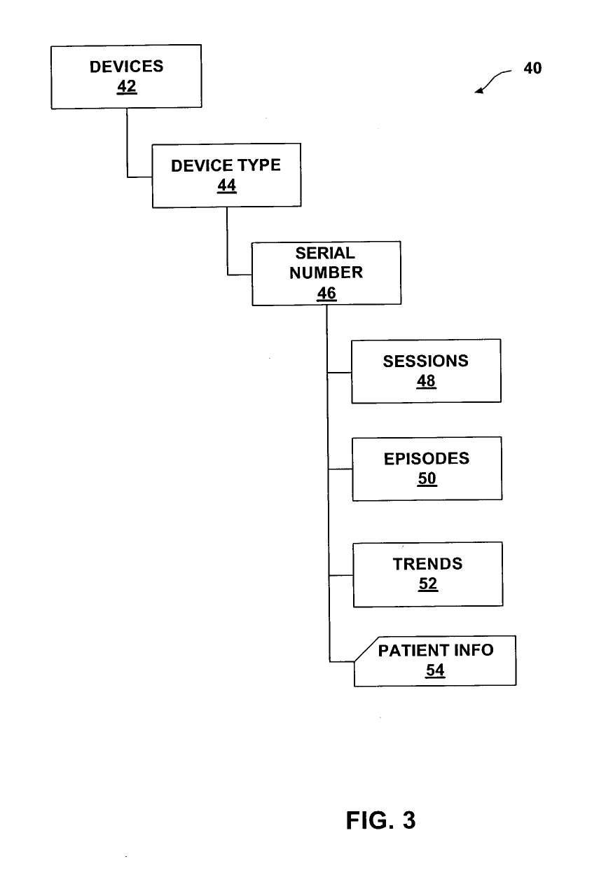

FIG. 3 is a block diagram illustrating an example embodiment in which XML data stores 24 (FIG. 2) are stored as separate XML files. In general, FIG. 3 illustrates a file structure 40, which allows a user, such as a clinician, to navigate to specific patient records and session data using the exposed directory structure via a file browser or a web browser. More specifically, file structure 40 includes a root directory DEVICES 42, which has one or more subdirectories DEVICE TYPE 44. Each directory DEVICE TYPE 44 includes directories for each particular device based on the serial numbers of the devices, i.e., directories SERIAL NUMBER 46. In other words, in the illustrated embodiment, data stores 24 organize session data received from programmers 6 by the type of medical device, such as pacemaker, glucose monitor, and the like, and the by the serial number of the device. In this manner, session data from each medical device 8 is stored under a respective directory structure associated with the device.

Further, translation engine 20 (FIG. 2) stores session data for each medical device 8 within a set of XML data stores, i.e., a set of directories SESSIONS 48, EPISODES 50, and TRENDS 52 that store XML data in a form that can be easily rendered for viewing by XSLT processor 27 and web server 30, as well as easily shared with others, such as remote clinic 16. More specifically, translation engine 20 processes XML session data 22 to separate the data for aggregation within SESSIONS 48, EPISODES 50, and TRENDS 52. In other words, translation engine 20 does not store session data 22 for a session within a single session file, but processes the session data to extract portions of the data based on XML data types. In particular, data that can either span, or be duplicated across, multiple patient sessions can be identified and extracted from the session data, and then recombined with other data of that type. For example, an episode that exists in multiple sets of received session data can be identified and extracted, with the instance having the most complete detailed data being added to the associated data store. The other duplicate data can be discarded. A user, such as a clinician, can then navigate all the recombined data, e.g., all of the episodes in an aggregated list, and is presented with a complete detail for the example episode, regardless of whether the detail spanned or was duplicated in multiple telemetry sessions. In this manner, translation engine 20 aggregates data across multiple visits by a patient, allowing a clinician to more easily view and interpret the historical data related to the patient. A single PATIENT INFO file 54 may be used to store data that is constant, such as a name of the patient, gender, date of birth, and the like.

Although illustrated as XML-based data files, XML data stores 24 may be stored in a database that supports XML. For example an XML database, or a relational database having integrated XML support may be used.

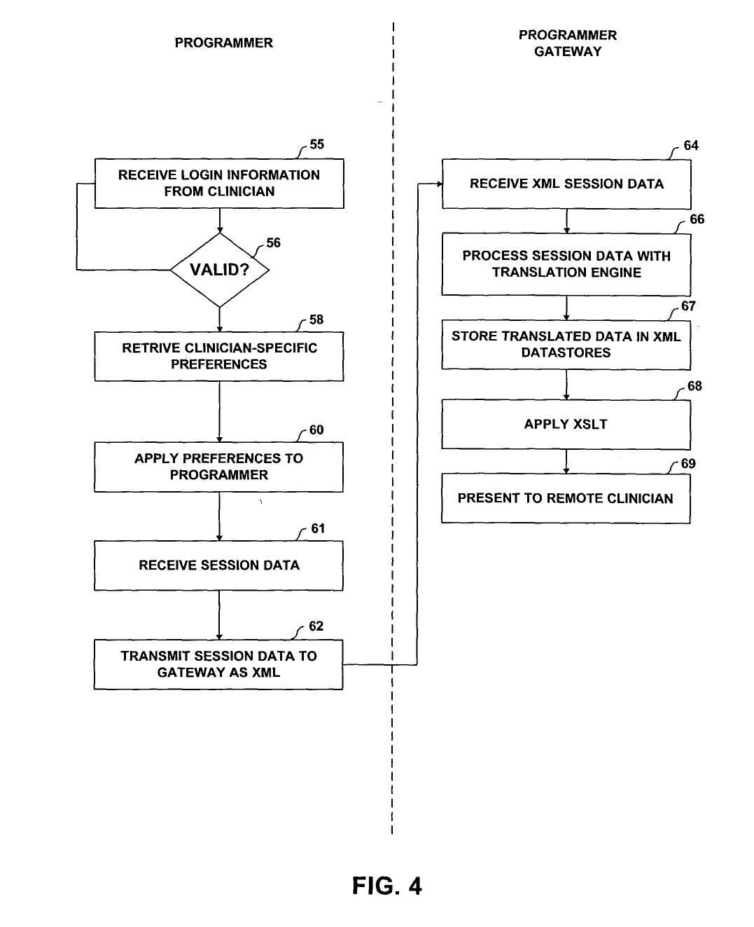

FIG. 4 is a flowchart illustrating example operation of system 2. Initially, a clinician 12A accesses a programmer 6, and may provide login information, such as a user name and password (55). In response, programmer 6 validates the login information to verify that the user is authorized to access the programmer (56).

If the validation is successful, programmer 6 may retrieve clinician-specific preferences, i.e., clinician-specific programmer configuration parameters, from a central location, e.g., programmer gateway 10 (58). Programmer 6 applies the retrieved preferences to modify its current configuration (60), thereby allowing each clinician to define customizations and preferences for universal application to any of programmers 6 upon access by the clinician. The aggregation and filtering enable previous clinician-based preferences and nominals to be accurately shared across programmers and internet-based user sessions, clinicians treating a patient, as well as members of physician groups, clinics, and hospitals.

Once configured, programmer 6 initiates communications with an MD 8, and interrogates the device to receive session data 22 (61). Programmer 6 transmits session data 22 to programmer gateway 10 in a form that complies with a data description language, e.g., XML (62). As described above, programmer 6 may include the constituent components of programmer gateway 10 described in FIG. 2, i.e., translation engine 20, XML data stores 24, instructions 26, XSLT processor 27, XSLT style sheets 28, and web server 30. In this manner, programmer 6 may generate local XML data stores for storing the session data, and may present the XML data stores to a clinician via a browser interface.

Upon receiving the XML session data 22 (64), translation engine 20 of programmer gateway 10 processes the session data for aggregation within XML data stores 24. For example, translation engine 20 may parse the session data to identify and extract specific session data based on the embedded XML data types, and may store the extracted session data within XML data stores 24 for aggregation with other session data previously captured from the device (67).

In particular, session data of a particular type can either span, or be duplicated across, multiple patient sessions. Translation engine 20 can identify and extract the data from the session data 22 based on data type, and then recombine the data within XML data stores 24 with other data of that type. For example, an episode that exists in multiple sets of received session data can be identified and extracted, with the instance having the most complete detailed data being added to the associated data store. The duplicate data can be discarded.

Programmer gateway 10 presents the aggregated data of XML data stores 24 by first applying XSLT style sheets 28 to transform the stored XML data into serialized HTML (68). Web server 30 of programmer gateway 10 communicates the HTML to a clinician in the form of one or more web pages or other viewable data, e.g., Flash, PDF, and the like, for display (70). In this manner, the clinician can navigate all the recombined data of a particular data type, e.g., all of the episodes in an aggregated list, and is presented with a complete detail for the example episode, regardless of whether the detail spanned or was duplicated in multiple telemetry sessions. By viewing data extracted from individual sessions, and aggregated with data of similar data types, e.g., episodes, clinician 18 may be able to more easily obtain a complete perspective on the session data obtained from a medical device.

The following illustrates an example of XML data stored within XML data stores 24. Specifically, the following illustrates a Session XML data type stored within SESSIONS 48 to describe a specific interrogation session of an MD 8.

<?xml version=“1.0” encoding=“UTF-8” ?>
<Session type=“ProgrammerExport”>
<SessionTimeDate>2000-01-01T12:22:48</SessionTimeDate>
<DeviceInformation>
<DeviceSerialNumber>IJF200204S</DeviceSerialNumber>
<DeviceModelName>AT 500</DeviceModelName>
<DeviceModelNumber>7253</DeviceModelNumber>
</DeviceInformation>
<PermanentParameters>
<PacingMode>DDDR</PacingMode>
<LowerRate units=“ppm”>60</LowerRate>
<UpperTrackingRate units=“ppm”>120</UpperTrackingRate>
<UpperSensorRate units=“ppm”>120</UpperSensorRate>
<OverdrivePeriod units=“min”>0</OverdrivePeriod>
<AtrialSensitivity units=“mV”>0.3</AtrialSensitivity>
<VentricularSensitivity units=“mV”>0.9</VentricularSensitivity>
</PermanentParameters>
<Episode id=“5”>
<Episode id=“4”>
<Episode id=“3”>
<Episode id=“2”>
<Episode id=“1”>
</Session>

The example data illustrates a session that occurred on Jan. 1, 2001 for device IJF200204S. Along with specific session parameters, the Session data type indicates that data was acquired during the interrogation session for five episodes. The following illustrates an example Episode data types that describes episode data extracted from session data 22. Translation engine extracts the Episode XML data, and stores the data separately within EPISODES 50 for aggregation with other episode data.

<Episode id=“5”>
<TimeDate>2000-06-01t03:17:43</TimeDate>
<Type>AF</Type>
<Duration>47 min</Duration>
+<MarkerSegment>
+<MarkerSegment>
+<IntervalSegment>
+<IntervalSegment>
+<AnnotationSegment>
+<WaveformChannel>
</Episode>

As illustrated, each Episode data type includes and identifier (ID), and includes additional data types of TimeDate, Type, and Duration. Further, each Episode data type may include one or more MarkerSegment data types, IntervalSegment data types, AnnotationSegment data types, and WaveformChannel data types that describe the data associated with the particular episode.

The following illustrates example data described by the MarkerSegment data type:

<MarkerSegment>
<SegmentOffset>0</SegmentOffset>
<SegmentTimeScale>1000</SegmentTimeScale>
<Marker Type=“AP”>9990</Marker>
<Marker Type=“VP”>10180</Marker>
<Marker Type=“AP”>10850</Marker>
<Marker Type=“VP”>11040</Marker>
<Marker Type=“AP”>11710</Marker>
<Marker Type=“VS”>11880</Marker>
<Marker Type=“AS”>12500</Marker>
<Marker Type=“VS”>12640</Marker>
<Marker Type=“AP”>13480</Marker>
<Marker Type=“VS”>13660</Marker>
<Marker Type=“AP”>14480</Marker>
<Marker Type=“VS”>14667</Marker>
<Marker Type=“AR”>14862</Marker>
<Marker Type=“VTS”>15049</Marker>
<Marker Type=“AFS”>15064</Marker>
<Marker Type=“AFS”>15228</Marker>
<Marker Type=“AFS”>15368</Marker>
<Marker Type=“AFS”>15524</Marker>
<Marker Type=“VP”>15547</Marker>
<Marker Type=“AFS”>15703</Marker>
<Marker Type=“AFS”>15882</Marker>
<Marker Type=“VP”>16046</Marker>
<Marker Type=“ATS”>16217</Marker>
<Marker Type=“AFS”>16388</Marker>
<Marker Type=“AFS”>16536</Marker>
<Marker Type=“VP”>16543</Marker>
</MarkerSegment>

The following illustrates example data described by the Intervalsegment data type:

<IntervalSegment>
<SegmentOffset>0</SegmentOffSet>
<SegmentTimeScale>1000</SegmentTimeScale>
<Interval EndOffset=“15064” Type=“A-A”>200</Interval>
<Interval EndOffset=“15064” Type=“V-A”>10</Interval>
<Interval EndOffset=“15228” Type=“A-A”>160</Interval>
<Interval EndOffset=“15368” Type=“A-A”>140</Interval>
<Interval EndOffset=“15524” Type=“A-A”>150</Interval>
<Interval EndOffset=“15547” Type=“V-V”>500</Interval>
<Interval EndOffset=“15547” Type=“A-V”>20</Interval>
<Interval EndOffset=“15703” Type=“A-A”>180</Interval>
<Interval EndOffset=“15703” Type=“V-A”>160</Interval>
<Interval EndOffset=“15882” Type=“A-A”>170</Interval>
<Interval EndOffset=“16046” Type=“V-V”>500</Interval>
<Interval EndOffset=“16046” Type=“A-V”>160</Interval>
<Interval EndOffset=“16217” Type=“A-A”>330</Interval>
<Interval EndOffset=“16217” Type=“V-A”>170</Interval>
<Interval EndOffset=“16388” Type=“A-A”>170</Interval>
<Interval EndOffset=“16536” Type=“A-A”>150</Interval>
<Interval EndOffset=“16543” Type=“V-V”>500</Interval>
<Interval EndOffset=“16543” Type=“A-V”>0</Interval>
</IntervalSegment>

The following illustrates example data described by the AnnotationSegment data type:

<AnnotationSegment>
<SegmentOffset>0</SegmentOffset>
<SegmentTimeScale>1000</SegmentTimeScale>
<Annotation DisplayLine=“1” Offset=“17293>Suspended for

00:00:08</Annotation>

<Annotation DisplayLine=“2” Offset=“16543”>Onset</Annotation>
<Annotation DisplayLine=“3” Offset=“25588”>Suspended for

00:47:09</Annotation>

Offset=“36848”>Termination</Annotation>
</AnnotationSegment>

The following illustrates example data described by the WaveformSegment data type:

<WaveformSegment>
<SegmentOffset>1724</SegmentOffset>
<s>-7</s>
<s>-8</s>
<s>-12</s>
<s>-9</s>
<s>-9</s>
<s>127</s>
<s>127</s>
<s>100</s>
</WaveformSegment>

The example Session data type and Episode data type and encapsulated data are illustrated for exemplary purposes. Translation engine 20 extracts the Session and Episode data from session data 22, and aggregates the data within Sessions 48 and Episodes 50 of XML data stores 24, respectively. For example, translation engine 20 determines whether the episode data was previously received from programmer 6 during an early visit by the patient, thereby avoiding redundant data storage that may be confusing to the clinician. In this manner, translation engine 20 aggregates similar data types such that a clinician can easily view and appreciate data collected over multiple sessions.

Translation engine extracts and processes other portions of session data 22 in similar manner to aggregate Trends 52, which represent series of collected data to reflect changes over a period of time. For example, session data 22 may include trend data for delivered therapy, battery life, or other variables. Translation engine 20 extracts the trend data based on the XML data types within session data 22, and determines whether the trend data was previously received from programmer 6 during an early visit by the patient. If not, translation engine aggregates the trend data within TRENDS 52.

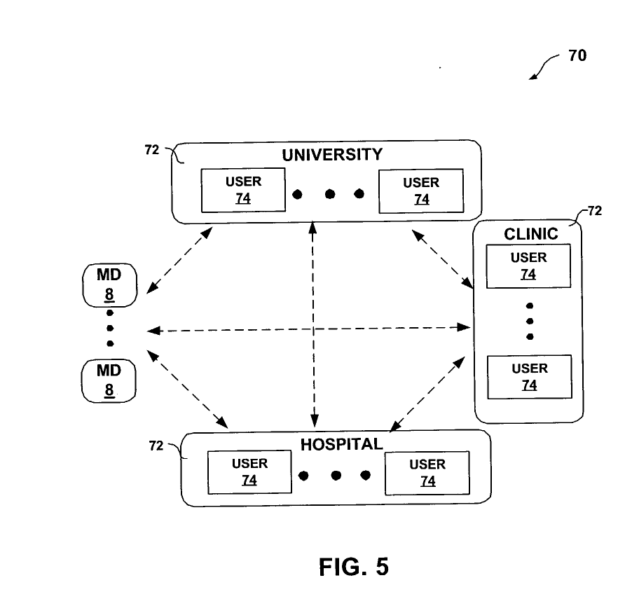

FIG. 5 is a block diagram illustrating a system 70 that uses a peer-to-peer (P2P) network protocol for file-based sharing of physiological data between distributed entities 72 and medical devices (MDs) 8. Entities 72 may comprise remote health care facilities, clinics, hospitals, universities, and other entities interested in viewing physiological data collected from one or more common patients, whose identities may or may not be maintained confidential by entities 72.

Entities 72 employ the techniques described herein to collect and aggregate physiological data from programmers (not shown) and may, for example, elect to “publish,” i.e., make available all or portions of the XML data stores 24 for viewing by authorized users 74. In addition, entities 72 may share customized XSLT style sheets 28 (FIG. 2) for providing different views and analysis of the aggregates physiological data.

In order to make the physiological information available for P2P file sharing, each entity may maintain a “peer” server that provides an operating environment for the P2P protocol. The peer server may control remote access to all or select portions of XML data stores 24. Alternatively, all or select portions of XML data stores 24 may be mirrored to the peer server. The distributed entities 74, therefore, need not necessarily communicate the data to a central patient management system, thereby giving each entity complete control over the physiological data that is available. Because the physiological data is stored and aggregated in a form that can easily be manipulated and displayed, e.g., using customized style sheets, the entities may render and display the physiological data differently as needed, yet maintain the data in a common, readily exchangeable format.

Each authorized user, such as a clinician authorized to review confidential patient information, may interact with entities 72 using a web browser executing on a client device, such as a remote diagnostic station, laptop computer, desktop computer, personal digital assistant (PDA), and the like. Each client device may provide an operating environment for a peer-to-peer client software application for sharing physiological data, e.g., in the form of XML-based data files. The peer-to-peer client software applications provide a search interface for identifying relevant data files based on search criteria, such as a patient name, device serial number, episode type, or the like, and allow the users to retrieve and view the physiological data directly from the source entity, i.e., the clinician or other organization that acquired and aggregated the physiological data.

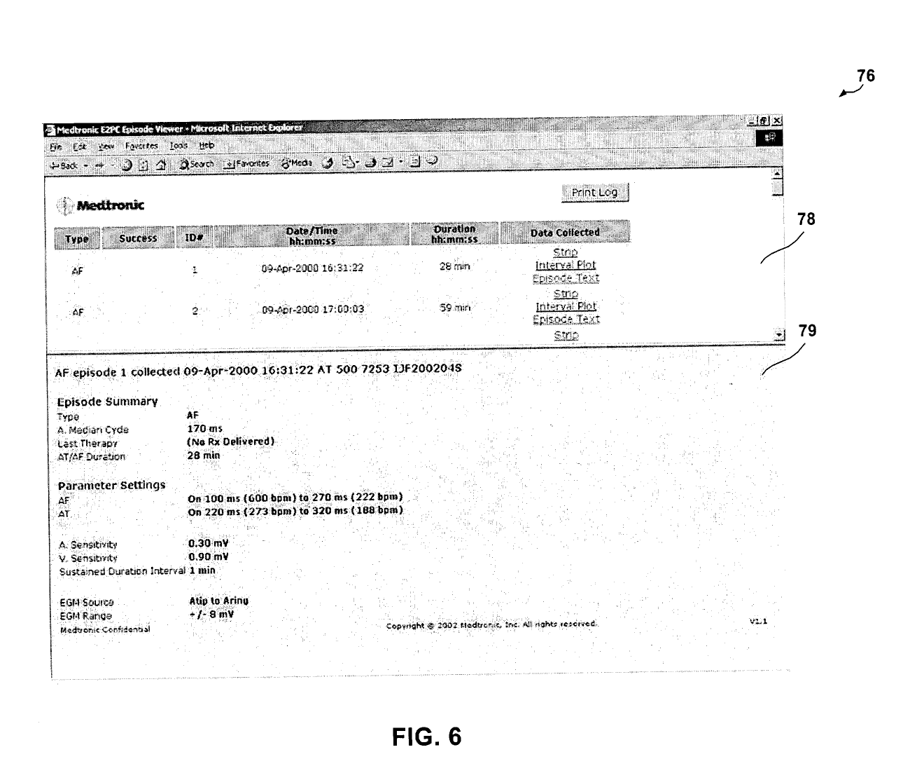

FIGS. 6-10 illustrate example web pages presented by web server 30 and XSLT processor 27 based on the aggregated data of XML data stores 24. The web pages may, for example, be displayed by a web browser, possibly in conjunction with a peer-to-peer file sharing application executing on a client device.

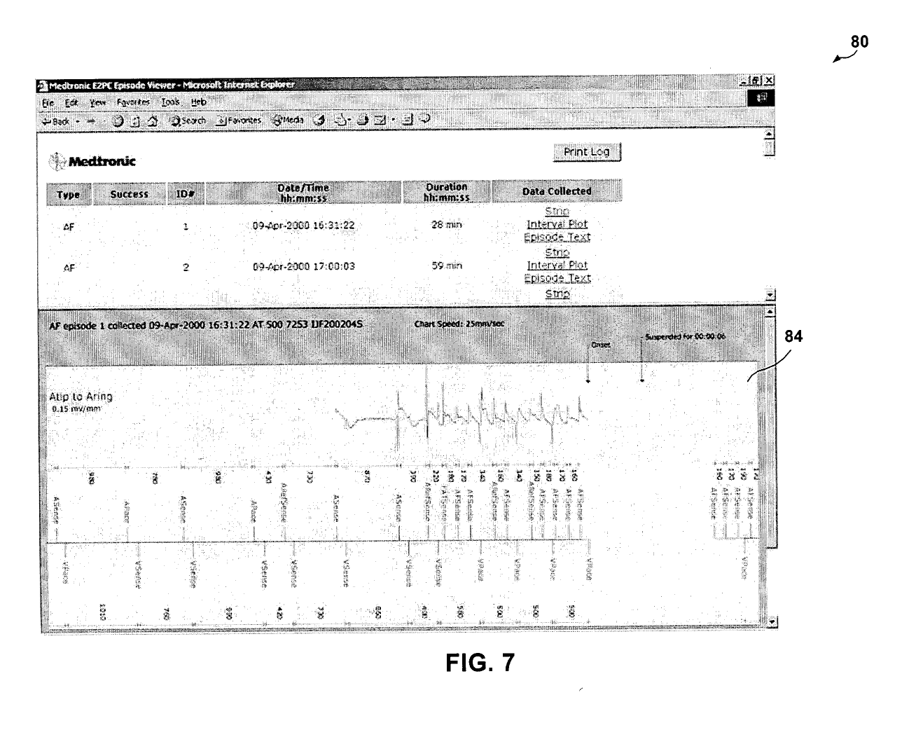

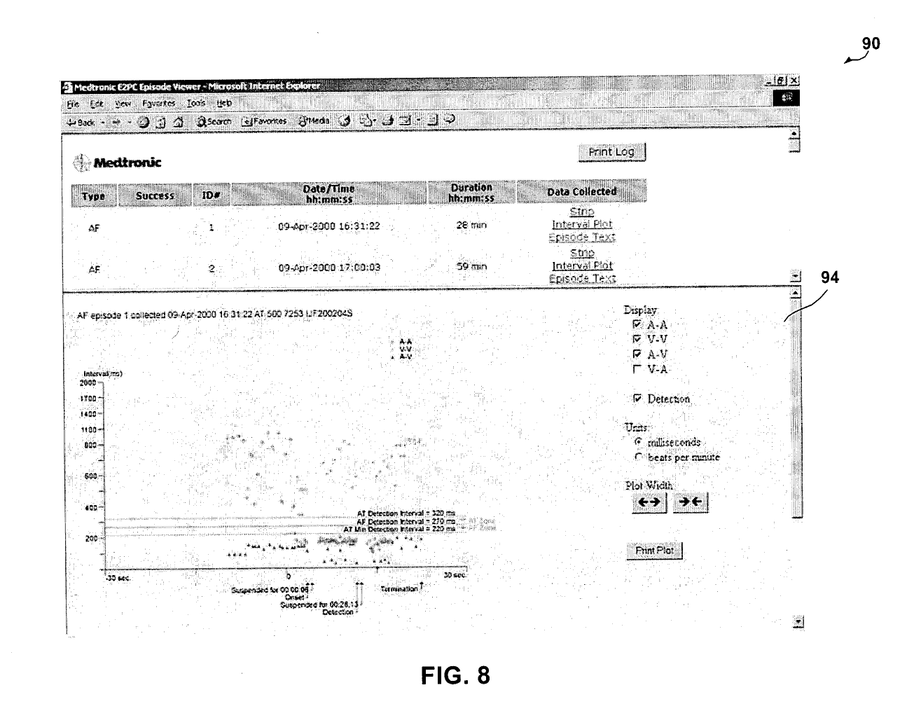

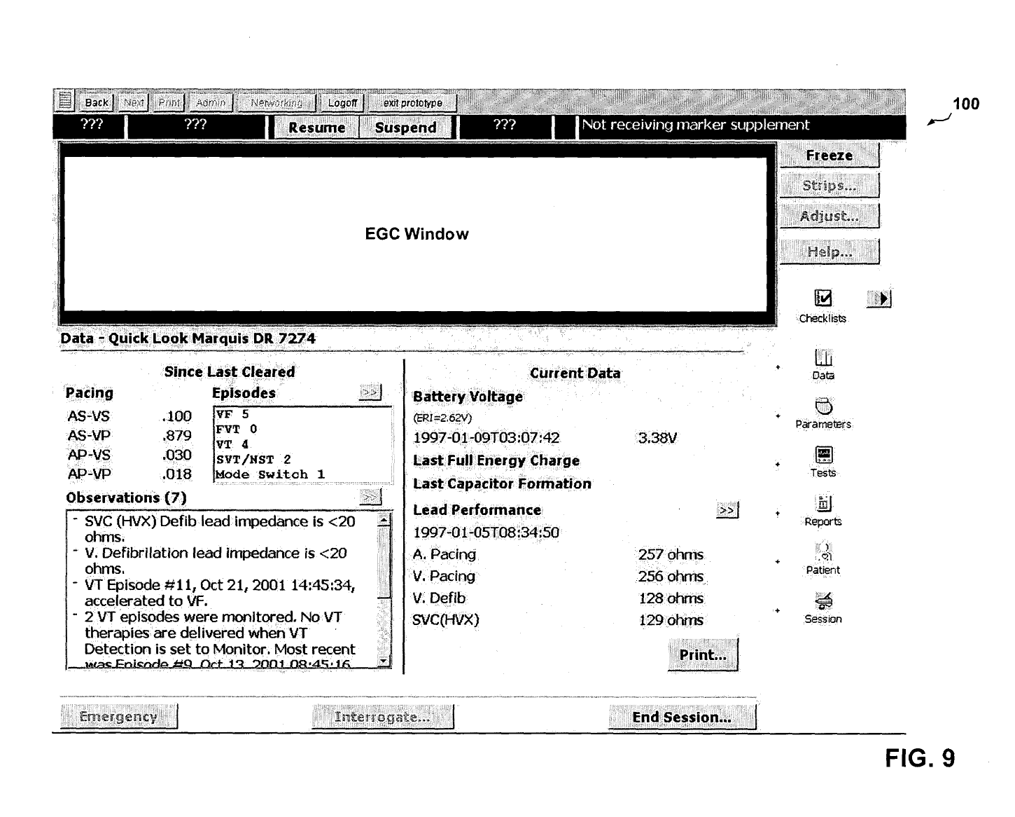

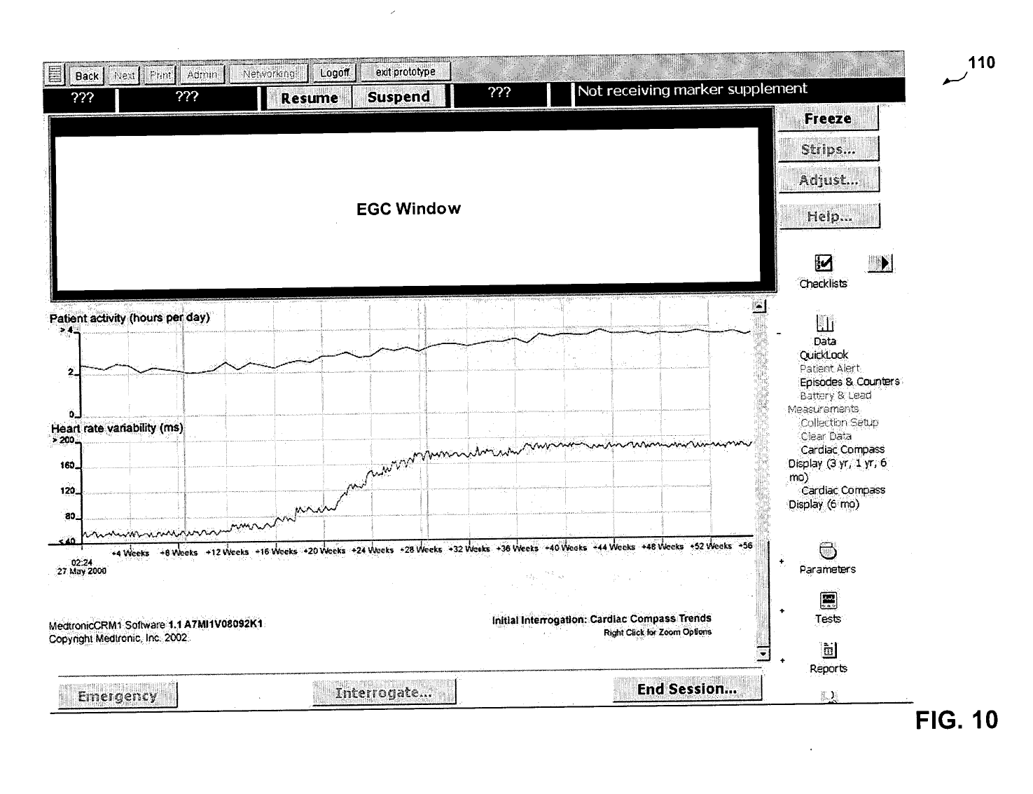

FIG. 6 illustrates a web page 76 having a first frame 78 that lists two AF episodes sensed by a particular medical device, possibly over multiple sessions. A second frame 79 displays the episode text collected from the programmer for the particular episode. FIG. 7 illustrates a web page 80 in which the frame 84 depicts a strip chart for the episode based on the data. FIG. 8 illustrates a web page 90 in which the frame 94 depicts an interval plot for the episode based on the data. FIGS. 9, 10 illustrates web pages 100, 110, respectively, and provide additional views of the aggregated data. As illustrated, the XML session data of XML data stores 24 can easily be shared between users, and viewed in a variety of ways by using different XSLT style sheets.

Various embodiments of the invention have been described. These and other embodiments are within the scope of the following claims.

What is claimed is:

1. A device comprising:
a data processing module to transform session data received from a medical device via a telemetry session into one or more web pages in accordance with one or more style sheets; and
a web server to present the web pages to a remote user.

2. The device of claim 1, wherein the data processing module comprises an Extensible Style Language Transformations (XSLT) processor to transform the session data into the web pages in accordance with XSLT style sheets.

3. The device of claim 1, further comprising a computer-readable medium to store the session data in a format that conforms to a data description language.

4. The device of claim 3, wherein the data description language comprises the extensible markup language (XML).

5. The device of claim 1, further comprising a translation engine to receive the session data and process the session data to aggregate the session data in one or more data stores and in a format that conforms to a data description language.

6. The device of claim 5, wherein data description language comprises the extensible markup language (XML), and the translation engine stores the session data in XML data files.

7. The device of claim 6, wherein the translation engine operates in accordance with translation instructions provided in at least one of Java, C, C++, Visual Basic, ASP, COM objects, Java Beans, ActiveX components, and Web Services.

8. The device of claim 1, wherein the device comprises a medical device programmer to receive the session data from a medical device via telemetry.

9. The device of claim 1, wherein the device comprises a programmer gateway to receive the session data from one of a plurality of medical device programmers.

10. A device comprising a translation engine to receive session data acquired via telemetry sessions with a medical device, and to process the session data for aggregation in one or more data stores in a format that conforms to a data description language.

11. The device of claim 10, wherein the translation engine selects respective data stores to store portions of the session data based on metadata of the data description language.

12. The device of claim 10, wherein data description language comprises the extensible markup language (XML), and the translation engine stores the session data in XML data files.

13. The device of claim 10, wherein the translation engine identifies any data that spans multiple sessions and recombines the session data with session data of similar type within the data stores, and discards any session data that is duplicated across multiple patient sessions.

14. The device of claim 10, further comprising:
a data processing module to transform the session data into one or more web pages in accordance with one or more style sheets; and
a web server to present the web pages to a remote user.

15. The device of claim 14, wherein the data processing module comprises an Extensible Style Language Transformations (XSLT) processor to transform the session data into the web pages in accordance with XSLT style sheets.

16. The device of claim 10, wherein the device comprises a medical device programmer to receive the session data directly from at least one of the medical devices.

17. The device of claim 10, wherein the device comprises a programmer gateway to receive the session data from one of a plurality of medical device programmers.

18. A system comprising:
a plurality of medical device programmers to collect session data from medical devices via telemetry sessions; and
a programmer gateway to receive the session data from the medical device programmers, and to process the session data for aggregation in one or more data stores.

19. The system of claim 18, wherein the session data includes metadata that conforms to a data description language, and the programmer gateway provides an operating environment for a translation engine to store portions of the session data within respective data stores based on the metadata.

20. The system of claim 19, wherein data description language comprises the extensible markup language (XML), and the translation engine stores the session data in XML data files.

21. The system of claim 18, wherein the programmer gateway further comprises:
a data processing module to transform session data acquired from a medical device into one or more web pages in accordance with one or more style sheets; and
a web server to present the web pages to a remote user.

22. The device of claim 21, wherein the data processing module comprises an Extensible Style Language Transformations (XSLT) processor to transform the session data into the web pages in accordance with XSLT style sheets.

23. A system comprising:
a plurality of distributed peer servers having data stores of session data received from medical devices via telemetry sessions; and
a client device executing a peer-to-peer client software application for accessing the session data directly from the distributed servers.

24. The system of claim 23, wherein the peer-to-peer client software application provides a search interface for identifying session data stored at the peer servers.

25. The system of claim 24, wherein the search interface of the peer-to-peer software application allows a user to search the session data based on at least one of a patient name and a device serial number.

26. The system of claim 23, wherein the peer servers are located at a plurality of entities that acquired the session data from medical devices via telemetry sessions with medical device programmers, and the peer-to-peer client software application allows a user to retrieve and view the session data directly from the peer servers of entities.

27. The system of claim 23, wherein the session data includes metadata that conforms to a data description language, and the peer servers execute a translation engines to store portions of the session data within respective data stores based on the metadata.

28. The system of claim 23, wherein data description language comprises the extensible markup language (XML), and the translation engine stores the session data in XML data files.

29. The system of claim 23, wherein each of the peer server further comprise:
a data processing module to transform session data into one or more web pages in accordance with one or more style sheets; and
a web server to present the web pages to a remote user via the peer-to-peer client software application.

30. A method comprising:
receiving session data acquired via telemetry sessions with a medical device; and
processing the session data for aggregation in one or more data stores and in a format that conforms to a data description language.

31. The method of claim 30, wherein the session data includes metadata that conforms to the data description language and includes elements that encapsulate the session data, the method further comprising selecting respective data stores to store portions of the session data based on the metadata.

32. The method of claim 31, wherein the data description language comprises the extensible markup language (XML), and the method further comprises storing the session data in XML data files.

33. The method of claim 32, further comprising processing the session data in accordance with translation instructions provided in an XML format.

34. The method of claim 30, further comprising transforming the session data acquired into one or more web pages in accordance with one or more style sheets

35. The method of claim 34, wherein transforming the session data comprises transforming the session data using an Extensible Style Language Transformations (XSLT) processor in accordance with XSLT style sheets.

36. The method of claim 34, further comprising presenting the web pages to a remote user via a web server.

37. The method of claim 30, further comprising presenting the session data to a remote user via a peer-to-peer software application.

38. The method of claim 30, wherein receiving the session data comprises receiving the session data directly from at least one of the medical devices.

39. The method of claim 30, wherein receiving the session data comprises receiving the session data at a programmer gateway from one or more medical device programmers.

40. A computer-readable medium comprising instructions to cause a processor to:
receive session data acquired via telemetry sessions with a medical device; and
process the session data for aggregation in one or more data stores in a format that conforms to a data description language.

41. The computer-readable medium of claim 40, wherein the session data includes metadata that conforms to the data description language and includes elements that encapsulate the session data, and the instructions cause the processor to select respective data stores to store portions of the session data based on the metadata.

42. The computer-readable medium of claim 41, wherein the data description language comprises the extensible markup language (XML), and the instructions cause the processor to store the session data in XML data files.

43. The computer-readable medium of claim 42, wherein the instructions cause the processor to process the session data in accordance with translation instructions provided in an XML format.

44. The computer-readable medium of claim 40, wherein the instructions cause the processor to transform the session data acquired into one or more web pages in accordance with one or more style sheets

45. The computer-readable medium of claim 44, wherein the instructions cause the processor to transform the session data using an Extensible Style Language Transformations (XSLT) processor in accordance with XSLT style sheets.

46. The computer-readable medium of claim 44, wherein the instructions cause the processor to present the web pages to a remote user via a web server.

47. The computer-readable medium of claim 40, wherein the instructions cause the processor to present the session data to a remote user via a peer-to-peer software application.

48. The computer-readable medium of claim 40, wherein the instructions cause the processor to receive the session data directly from at least one of the medical devices.

49. The computer-readable medium of claim 40, wherein the instructions cause the processor to receive the session data at a programmer gateway from one or more medical device programmers.

50. A method comprising:
receiving login information from a clinician;
accessing clinician-specific preferences based on the login information; and
applying the clinician-specific preferences to a medical device programmer.

51. The method of claim 50, further comprising validating the login information to verify that the clinician is authorized to access the programmer.

52. The method of claim 50, wherein receiving login information from a clinician comprises receiving a user name and password.

53. The method of claim 50, wherein accessing clinician-specific information comprises retrieving the clinician specific preferences from a programmer gateway.
